(19) United States
(12) Patent Application Publication
(10) Pub. No.: US 2025/0034905 A1
(43) Pub. Date: Jan. 30, 2025

(54) TWIST ON THE HAND TO REPLACE THE LOCK CORE STRUCTURE

(71) Applicant: SHENZHEN HUIKAIDA TECHNOLOGY CO.,LTD, Shenzhen (CN)

(72) Inventor: HE ZHANG, Guangzhou (CN)

(21) Appl. No.: 18/465,394

(22) Filed: Sep. 12, 2023

(30) Foreign Application Priority Data
Jul. 24, 2023 (CN) 202321953244.2

(51) Int. Cl. E05B 3/04

(52) U.S. Cl. CPC E05B 3/04

(57) ABSTRACT

A twist hand replacement lock core structure, including: a face cover, the face cover is provided with a lock core structure, the lock core structure is provided inside the rotating member, the turn member side is connected to a twist hand, the turn member and the twist hand are provided with a hand screw. The invention provides a twisted hand replacement lock core structure, The hand screw can lock the rotating parts and twist hand, When the lock core is damaged or the lock core needs to be replaced, The lock core structure can be removed and replaced by a wrench, This can realize the disassembly and replacement of the lock core structure from the handle part, Can adapt to the key to match the lock core structure, And only if entering the correct password, After turning the handle to reach the specified position.

### CROSS-REFERENCE TO RELATED APPLICATIONS

This is a U.S. patent application which claims the priority and benefit of Chinese Patent Application Number 202321953244. 2, filed on Jul. 24, 2023, the disclosure of which is incorporated herein by reference in its entirety.

### TECHNICAL FIELD

The present disclosure relates to the lock for the door, especially to a hand-replacement lock core structure.

### BACKGROUND

The lock is placed on an object that can be opened and closed, and can be opened with a key or password.

Mechanical password lock on the current technology, is enter the correct password, in the external twist hand or handle can turn to open the door, but because of the internal structure of the lock is relatively complex, so in the front of the position behind the door lock panel is not can replace the lock core space, and for need to replace the lock core users, in the door lock disassembly replacement will cause inconvenience.

Therefore, this invention provides a twist hand to replace the lock core structure to solve the above technical problems.

### SUMMARY

The present disclosure provides a twist structure of replacing the lock core, which solves the problem of the inconvenience caused by the complicated rotation of the internal structure of the door lock in the position behind the front panel of the door lock, resulting in the replacement of the door lock.

In order to solve the above technical problems, the invention provides a twisted hand replacement lock core structure, comprise: face cover and lock core structure.

Said face cover is provided with a rotating member in its inside;

Said lock core structure is provided inside of the rotating member, a side of rotating member connected the twist hands with screw.

In some embodiment, there are screw holes matching the hand screws between the rotating part and the twist hands.

In another embodiment, the surface of the face cover is provided with a password controller.

In another embodiment, a side of the face cover is connected with a storage assembly, said storage assembly is comprising a storage box. said storage box have a side to rotated and connected with a cover plate by a rotating shaft.

In another embodiment, One end of the cover plate and one side of the storage box are provided with matched fixings.

In another embodiment, there are several rubber pads connected around the inner wall of the storage box.

In another embodiment, the storage box acts on the storage of the wrench.

Compared with the related techniques, the invention replaces the lock core structure which has the following beneficial effects as follow:

The present disclosure provides a twisted hand replacement lock core structure, Set the hand screw between the rotating parts, lock core and twist hand, The hand screw can lock the rotating parts and twist the hand, When the lock core is damaged or the lock core needs to be replaced, The lock core can be removed and replaced by a wrench, This can realize the disassembly and replacement of the lock core from the handle part, Can adapt to the key to match the lock core, And only if entering the correct password, After turning the handle to reach the specified position, Only when the lock core can be replaced, If the door lock is closed, Incorrect password entry, The screw holes in the hand will be covered, Will not be exposed, While ensuring the replacement of the lock core, it increases the effect of anti-theft.

### BRIEF DESCRIPTION OF DRAWINGS

FIG. 1 is a schematic diagram of a first embodiment of the lock core structure provided by the invention;

FIG. 2 is a schematic diagram of the twisted hand shown in FIG. 1;

FIG. 3 is a side view of the face cover shown in FIG. 1;

FIG. 4 is a schematic diagram of the surface cover and the rotating member shown in FIG. 1;

FIG. 5 is a schematic diagram of the first working state structure of the overall device;

FIG. 6 is a schematic diagram of the second working state structure of the apparatus shown in FIG. 5;

FIG. 7 is a three-dimensional structural diagram of the overall working state of the device.

In the FIG, the representation of each reference sign is as follows.
1, face cover, 2, rotating member, 3, lock core structure, 4, twist hand, 5, hand screw, 6, screw hole, 7, password controller, 8, wrench.

### DETAILED DESCRIPTION

Implementations of the present disclosure will now be described, by way of embodiments only, with reference to the drawings. It should be understood that the specific embodiments described here are only used to explain but not to limit the present application. Based on the embodiments in the present application, all other embodiments obtained by one ordinary skill in the art without creative labor is within the scope of the present application.

The invention is further explained below in combination with the attached drawings and the embodiment.

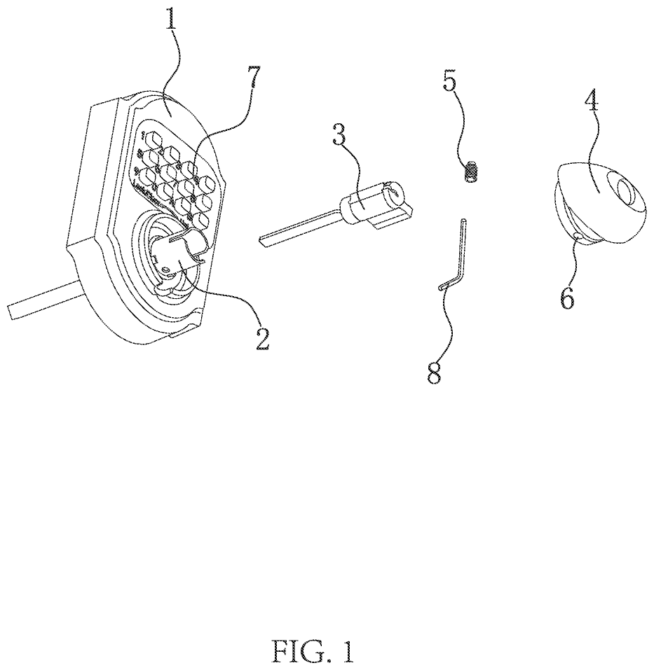

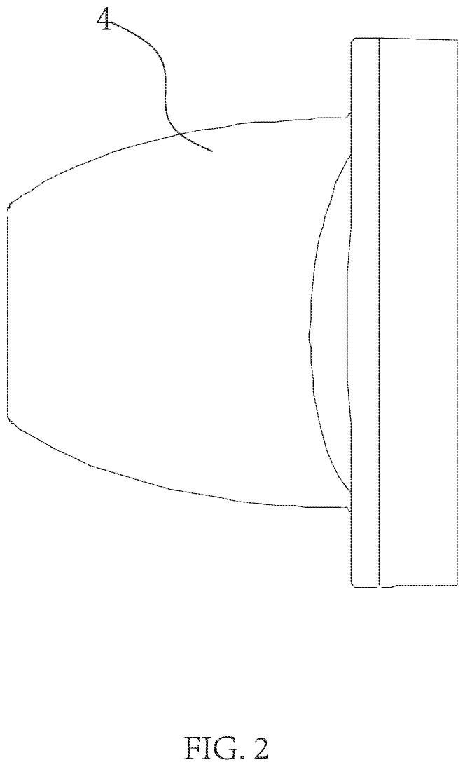

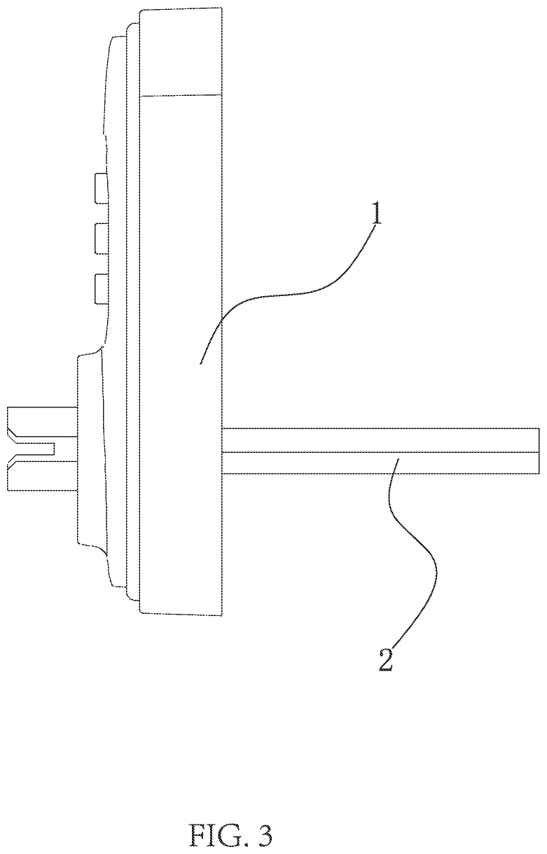

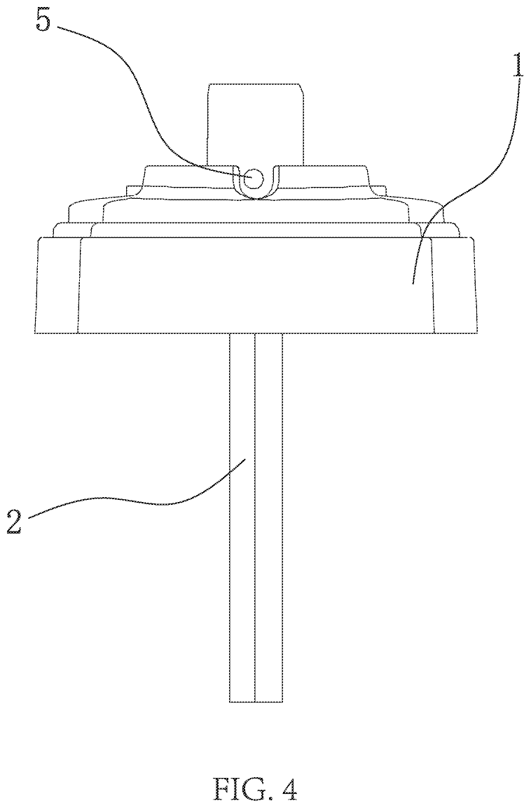

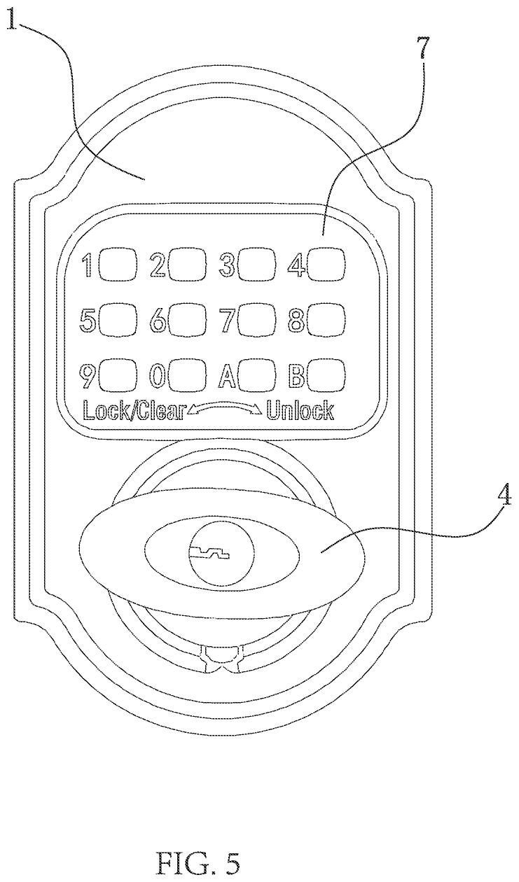

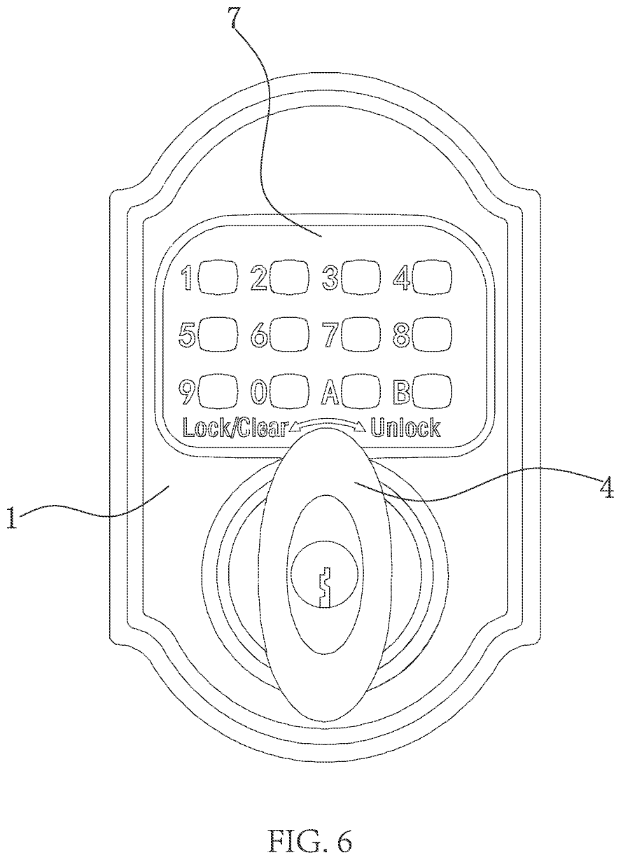

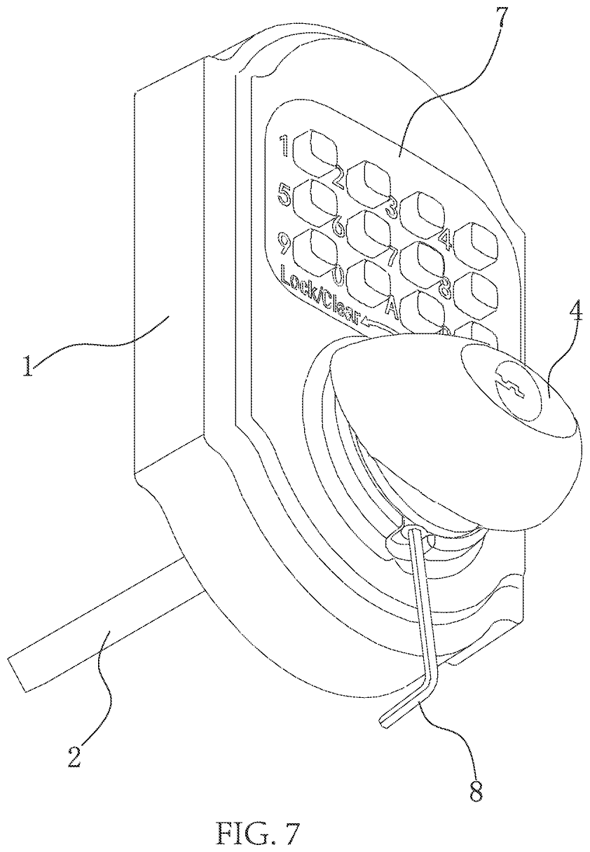

Referring to FIG. 1,-7, FIG. 1 is a schematic diagram of a first embodiment of the lock core structure provided by the invention; FIG. 2 is a schematic diagram of the twisted hand shown in FIG. 1; FIG. 3 is a side view of the face cover shown in FIG. 1; FIG. 4 is a schematic diagram of the surface cover and the rotating member shown in FIG. 1; FIG. 5 is a schematic diagram of the first working state structure of the overall device; FIG. 6 is a schematic diagram of the second working state structure of the apparatus shown in FIG. 5; FIG. 7 is a three-dimensional structural diagram of the overall working state of the device.

A twist on the hand to replace the lock core structure, which comprise:
Face cover 1 and wrench 8, the face cover 1 is provided with a rotating member 2;
the lock core structure 3 is provided on one side of the rotating member 2 connected with a twist hand 4 and the hand screw 5 is provided between the rotating member 2 and the twist hand 4.

There is the screw hole 6 between the rotating member 2 and the hand screw 5.

The surface of the face cover 1 is provided with a password controller 7.

Referring to FIG. 5 and FIG. 6, obvious, the unlocked state means that the twist hand 4 can be unscrewed clockwise to reveal the hole position of hand screw 5, the hand screw 5 will vertical blocked by the door handle when it is not unlocked.

This invention can replace the lock core assembly position is outside the front panel of the door lock, Covered by a twisted hand or handle, Twist the hand or handle through a locking screw is confined to the front panel, Will not be removed to replace the lock core, Only after entering the correct password, When the hand or handle is rotate, In turning the twist hand or handle to a specific position, Expose the locking screw holes, The user can remove the twist hand or handle by releasing the locking screw, To replace the external lock core, When the door is locked, When the hand or the hand is not turning, A protective ring on the door lock panel will cover this screw hole, The person outside the door is unable to loosen the locking screw and remove the twisting hand or handle.

The working principle of replacing the lock core structure is as follows:

When unlocking the lock, use the screw hand screw 5, take out the twist hand 4, and then take out the lock core structure 3 for replacement.

Rewing twist hand 4 requires screw the tip of hand screw 5 into screw hole 6.

Compared with the related techniques, a mechanical lock password setting and reset structure provided by the present invention have the following beneficial effects:

The disclosure provides a twisted hand replacement lock core structure, Set hand screw 5 between rotating member 2, lock core structure 3 and twist hand 4, Hand screw 5 can lock the rotating member 2 and twist hand 4, When the lock core structure 3 is damaged or needs to be replaced, Lock core structure 3 can be removed and replaced by wrench 8, This can realize the disassembly and replacement of the lock core from the handle part, And only if entering the correct password, After turning the handle to reach the specified position, Only when the lock core can be replaced, If the door lock is closed, Incorrect password entry, The screw holes in the hand will be covered, Will not be exposed, While ensuring the replacement of the lock core, it increases the effect of anti-theft.

The above is only the embodiment of the disclosure, not therefore limit the scope of the patent of the disclosure, all using the contents of the specification and the drawings of the equivalent structure or equivalent process transformation, or directly or indirectly in other related technical fields, the same is included in the scope of patent protection of the disclosure.

What is claimed is:

1. A twist-hand replacement lock core structure characterized by:
Face cover, the inner part of the face cover is provided with a rotating member;
lock core structure is provided inside of the rotating member, a side of rotating member connected the twist hands with screw.

2. The screw hand replacement lock core structure according to claim 1, wherein the screw hole is provided between the rotating member and the hand screw.

3. The screw replacement lock core structure according to claim 1, wherein the face cover is provided with a password controller.

4. The twist hand replacement lock core structure according to claim 1, wherein one side of the face cover is connected with a storage assembly, the storage assembly comprises a storage box, and one side of the storage box is connected with a cover plate through a rotating shaft.

5. The screw hand replacement lock core structure according to claim 4, wherein one end of the cover plate and one side of the storage box are provided with matched fixings.

6. The replacement lock core structure according to claim 5, wherein there are several rubber pads connected around the inner wall of the storage box.

7. The lock core structure according to claim 5, wherein the storage box is applied on the storage of the wrench.
